(19) United States
(12) Patent Application Publication
(10) Pub. No.: US 2009/0144269 A1
(43) Pub. Date: Jun. 4, 2009

(54) RESOLVING UNKNOWN MAILBOXES

(76) Inventors: Jean-Luc Collet, La Gaude (FR); Francois-Xavier Drouet, La Gaude (FR); Carole Truntschka, Saint-Laurent-Du-Var (FR)

Correspondence Address: HOFFMAN WARNICK LLC, 75 STATE ST, 14 FL, ALBANY, NY, 12207, US

(21) Appl. No.: 12/323,609

(22) Filed: Nov. 26, 2008

(30) Foreign Application Priority Data
Dec. 3, 2007 (EP) 07301617.2

(51) Int. Cl. G06F 7/06; G06F 15/16; G06F 17/30

(52) U.S. Cl. 707/5; 709/206; 709/238; 707/E17.014

(57) ABSTRACT

The present invention relates to a method and system for processing electronic mails in case of a address change of the addressee. It provides an ECOA resolving process of searching for a new or alternative address for this addressee, optionally triggered in case of unknown address or non delivery notification message. This process comprises forwarding the email under ECOA resolving from one MTA to another MTA in the network, for trying to reach a MTA connected with a database where old and new addresses are memorized in association. Such resolving forwarding is done according to specific routing tables, possibly independent from DNS routing server, which may include specific or local analysis rules based on the invalid address.

### FIELD OF THE INVENTION

The present invention relates to a method and system for processing electronic mails in case of an address change of the addressee.

### BACKGROUND OF THE INVENTION

Electronic mail, or e-mail, is commonly used for communicating through the Internet or through an IP network or an intranet or extranet network.

Users often change their email address, e.g., when leaving their company or changing their internet access provider. Their old mailboxes are then deleted, thus risking a loss of contact with correspondents who knew only this old address. Transitory solutions are sometimes proposed by the old provider, such as temporary aliases, but only for a limited period of time and not always technically sufficient. Solutions are proposed, such as by document US 2002/0010745, or by specialized websites, which maintain a database of associated old and new addresses in case of Email Change Of Address (ECOA). Users register themselves in this database, which offers services for business file updating, or forwarding old address emails toward the new address, when requested by an email system. Users may also be asked permission, before the new address is returned to the requesting system.

However, such methods are not always satisfactory. For example, forwarding may not work when the email system of the sender is not affiliated to the same database in which the intended recipient registered his address change. Also, such databases may not be fully or reliably compatible with the concerned email system.

### SUMMARY OF THE INVENTION

The present invention processes address changes and improves on known methods and systems, by, for example: widening the search field of registered address changes to several registering databases; enabling address change resolution at an email system not connected to such registering databases; providing flexible, efficient and reliable implementation and deployment of such features throughout the existing network(s); and enabling more flexibility and efficiency to such features, especially in terms of compatibility, traffic optimization and reliability.

The present invention provides a method for processing electronic mail in a network comprising a plurality of mail servers, the method comprising: at least a first mail server receiving a notification message representing an impossibility to reach a first electronic mail address for which a given electronic mail was intended; the first mail server carrying out a resolving forwarding step comprising sending all or part of the electronic mail to at least a second mail server, together with a datum indicating that a second substitution mail address is to be searched for in replacement of the first mail address.

Such a mail server may be the first one processing the email, e.g., the sending mail server of the sender's access provider. This mail server may also be any one of the mail servers within the basic processing chain, i.e., any one of the mail servers that relay for forwarding the unknown address or non delivery notification message back to the sender.

Thus, emails with any kind of unknown intended recipient address may be forwarded to other mail servers until a replacement or updated address is found, or until it is ascertained that no replacement address has been registered for this unknown address within all the connected mail servers.

Further, this method enables every such mail server to benefit from substitution address databases that it is not aware of nor compatible with, merely by implementing such a simple forwarding feature.

This method may furthermore comprise a plurality of iterations of the step of sending the electronic mail from first mail server to second mail server together with a datum indicating to search for a substitution address.

Such iterations may also be implemented in intermediary servers that do not have the capacity to start such a resolving process, nor the capacity to consult replacement databases for solving the case. The global resolving capacity is thus improved through widening the panel of involved resolving servers and databases.

Typically, this method furthermore comprises: at least one mail server receiving the electronic mail together with a datum indicating to search for a substitution address; the mail server receiving from at least one database a second electronic mail address, to be used as a substitution address for the first electronic mail address; the mail server delivering the electronic mail to the substitution address, or transmitting the substitution address towards at least one other mail server with the substitution address as a replacement for the first mail address.

The substitution address found may thus be used as a new intended recipient address.

In an embodiment, at least one mail server of this method is working as a Mail Transport Agent (MTA), such as in a SMTP server, or as a Mail Delivery Agent (MDA) within the Internet or an intranet type or extranet type network.

Also, the resolving forwarding may furthermore comprise sending an identification datum, or anti-loop code, identifying that the electronic mail has already been processed for substitution address by the at least one mail server.

It is thus ascertained that the email under ECOA resolving is not transmitted more than is necessary or useful.

Such an anti-loop code may be similar or integrated in the standard anti-loop code used by mail servers for standard routing electronic mails from senders to intended recipients, i.e., for the Internet by using the “MX” part of the DNS (Domain Name Servers) routing tables.

Furthermore, such a method may comprise comparing the first mail address with at least one routing table, termed resolving, for selecting the second mail server.

Such a mechanism may thus be easily implemented, as very similar to existing routing technologies such as the DNS routing tables.

However, it may also be implemented through routing tables that are independent and/or separate from the DNS routing tables, thus simplifying implementing through step by step deployment, and enabling local deployment or deployment specific to restricted particularities. Linguistic particularities or specific character codes, e.g., Asiatic or Arabic characters, may thus be implemented in different ways or even provide specific advantages. The routing capabilities may also be optimized with phonetic algorithm, log requests, or other features specific to the first address or its user.

Typically, the invention proposes to provide an extension inside the SMTP server(s) so as to using existing infrastructure based on MTA. Thus, if a MTA is not able to solve or trigger an ECOA resolving, it is transparent for it. Otherwise, when a MTA is able to manage this extension, it tries to identify a MTA able to solve the problem, via the routing table.

The invention thus proposes to re-use the mechanism of anti-loop inside the MTA traffic capabilities, or a similar mechanism implemented with common software and/or hardware tools.

Also, this routing process for ECOA resolving may comprise a hierarchical treatment of the domain name of the first address, similar to the one used for standard mail dispatching.

Local or global organizations may thus provide routing capabilities to have several ECOA resolving servers per domain.

Advantageously, such a method may thus further comprise: extracting at least one key string including all or part of the user part of the first electronic mail address; and comparing the key string with at least one routing table, termed resolving, for selecting the second mail server.

In particular, this feature may implement a hierarchical treatment of this user part of address, according to one or several features of such email address or of its user part.

Thus, in such a method, the extracting or comparing of the key string may comprise at least one linguistic analysis treatment.

Optionally, the method according to the invention may furthermore comprise the step of at least one mail server sending the substitution address as an update for the first address towards at least one mailbox routing table used in the network for routing electronic mails from senders to intended recipients, i.e., in the MX part of the DNS routing tables.

Maintenance of these routing tables is thus quicker and more efficient.

The invention also provides a system for carrying out such a method.

### BRIEF DESCRIPTION OF THE DRAWINGS

The new and inventive features believed characteristic of the invention are set forth in the appended claims. The invention itself, however, as well as modes of use, further objects and advantages thereof, will best be understood by reference to the following detailed description of an illustrative detailed embodiment when read in conjunction with the accompanying drawings.

FIG. 1 is an schematic architecture of an implementation of an embodiment of the invention throughout the MTAs of the Internet.

FIG. 2 is a schematic block diagram of an embodiment of the method according to the invention.

FIG. 3 is a schematic diagram of an ECOA resolving routing table in an embodiment of the invention, based on hierarchical routing by domain name.

FIG. 4 is a schematic diagram of an ECOA resolving routing table in an embodiment of the invention, based on hierarchical routing by user part analysis.

FIG. 5 is a schematic diagram of an ECOA resolving routing table in an embodiment of the invention, based on hierarchical routing by user part linguistic analysis.

### DETAILED DESCRIPTION OF THE INVENTION

In the following specification, elements common to several figures are referenced through a common identifier.

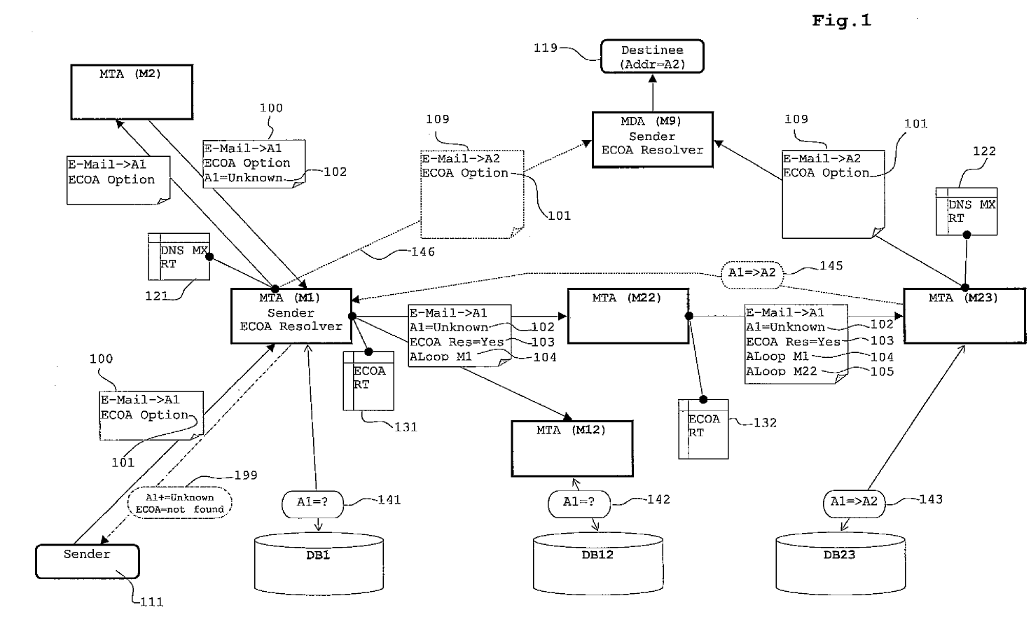

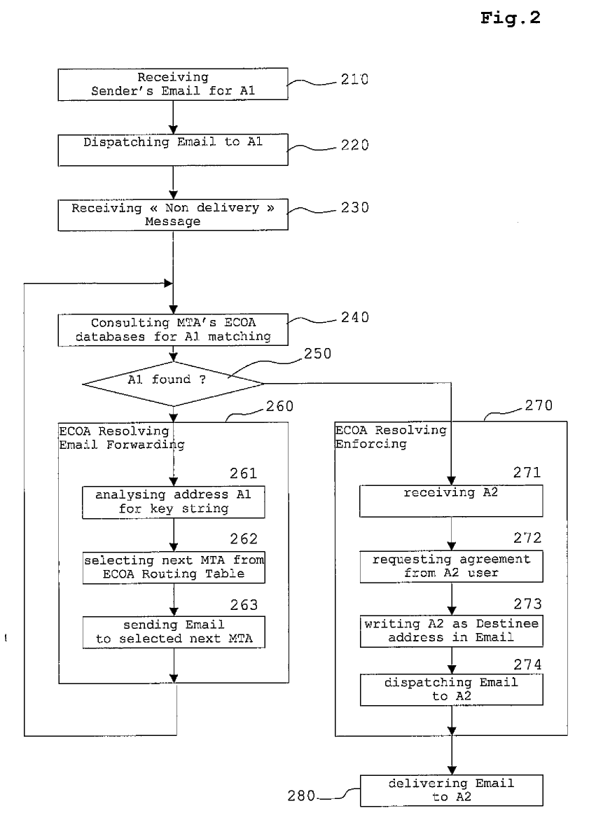

FIG. 1 and FIG. 2 schematically represent the processing of an email through an ECOA resolving process according to an embodiment of the invention. In the present description, most of transmission operations specified as transmitting email 100 may also pertain to only partial data of this mail or representing this mail, such as the mere header of the original mail.

An email 100 is transmitted on the Internet by a sender user 111 towards an intended recipient user 119, with a intended recipient address A1 which is an old address of intended recipient 119. This email is received 210 by the Mail Transport Agent Ml of a mail server, e.g., an SMTP mail server of the Internet Service Provider (ISP) of the sender 111.

The mail server Ml dispatches 220 the email towards one or several other MTA(s) M2, according to the mail part (MX) of one or several routing table(s) 121 maintained by the DNS servers(s).

If the email address A1 is no longer valid, the M1 MTA receives a “non delivery” notification message, typically the email header 100 together with an “A1 unknown” or “non delivery” data 102.

If the email 100 was emitted with an optional datum 101 requesting for ECOA resolving in case of non delivery notification due to a intended recipient unknown address, the MTA M1 starts an ECOA resolving process on reception 230 of this notification message 102.

Optionally, the ECOA resolving process could be started by another MTA such as the MTA M2, e.g., if the SMTP server of the ISP does not include such an ECOA resolving extension.

If the MTA M1 server is enabled with ECOA resolution features, this MTA M1 server firstly tries to find by itself a substitution address for the invalid address A1, by consulting 240 any internal or external database DB1 according to known methods. In case 250 of no database or of no result 141, MTA M1 forwards the email 100 to one or several other MTA enabled servers M12, M22. This or these M12 and M22 MTAs are selected according to an ECOA resolving routing table 131.

This email 100 is here transmitted 260 to MTAs M12 and M22 together with a datum 103 indicating that an ECOA resolving process is now active for this mail.

Also, an anti-loop code or datum 104 is transmitted associated with email 100, meaning that this ECOA resolving process has already been processed by M1 MTA.

On reception of the email 100 under ECOA resolving, M12 consults all the databases DB12 available at its level, and receives a negative or no match answer 141. When receiving the email 100, MTA M22 forwards it one step more with its own anti-loop code 105 to another MTA M23 according to an ECOA routing table 132, even if it has no substitution research 240 capacity by itself.

It should be noted that the invention may also be implemented so as to enable this forwarding 260 even if MTA server M22 is not at all upgraded with such an ECOA resolving extension. For instance, forwarding by M1 is done without the non delivery data 102 and with the ECOA resolution data 103. Anti-loop code 104 may then be in the same format as the standard mail dispatching anti-loop datum. The email 100 is then processed by the standard MTA as a valid email. Any further upgraded MTA will however still be able to read the ECOA resolution datum 103, thus going on with the ECOA resolution processing.

An ECOA enforcing process 270 is started when an ECOA able MTA server M23 finds 143, 271 a substitution address A2 for the invalid address A1 of email 100, from a database DB23

Optionally, agreement for using such a substitution address may be requested 272 from the user owning it A2.

ECOA enforcing process then comprises writing 273 substitution address A2 in the email 100 header as intended recipient address, in replacement of initial address A1. ECOA operations are then erased or marked as closed (for avoiding ECOA looping), and the modified email 109 is dispatched 274 again.

Optionally, the ECOA optional request 101 may be maintained, so as to enable a new ECOA resolution if the new address A2 is also invalid.

In a non-exclusive alternative (in dotted line on FIG. 1), found substitution address A2 is transmitted 145 by resolver MTA M23 to another server, e.g., the MTA M1 that started the ECOA resolving process or possibly (not shown) the Mail Delivery Agent (MDA) servicing the intended recipient user 119. This receiving server M1, M9 then enacts the substitution 272, 273 and dispatching 274 of the modified email 109.

If the intended recipient 119 refuses the updating or no substitution address is found, according to a mechanism similar to the standard DNS routing mechanism, an specific error or information message 199 may be transmitted to the sender 111, informing that ECOA resolving was not successful.

Routing Mechanism

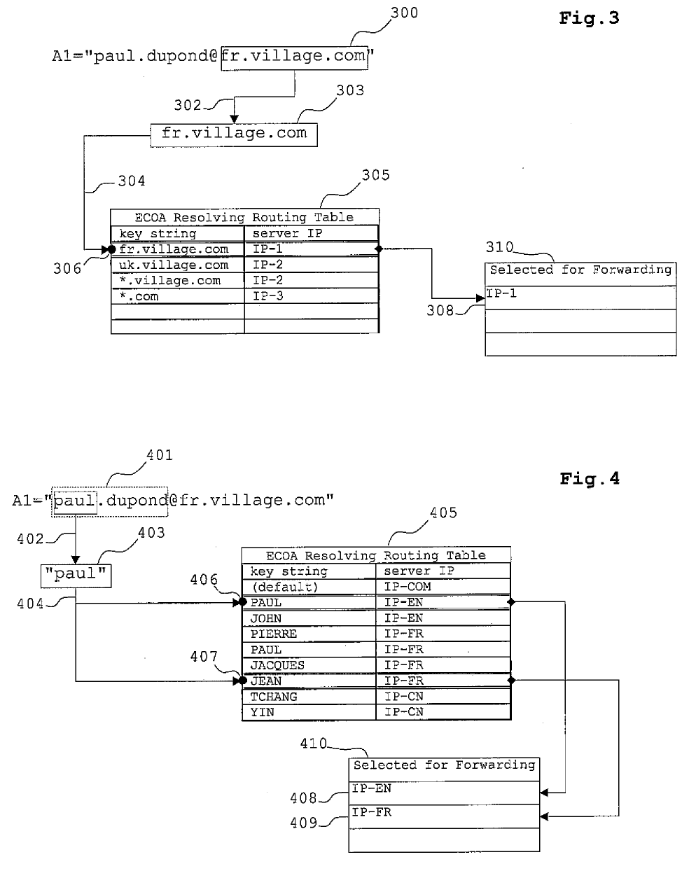

FIG. 3 to FIG. 5 show several examples for a routing table 131, 132 for selecting 262 the next MTA in the ECOA resolving Forwarding step 260 of such a resolving process.

In FIG. 3, the invalid first email address A1 (paul.dupond@fr.vilage.com) is used for comparing 304 with the records of the ECOA routing table 305. An analysis 261 is done which comprises extracting 302 a key string 303 including all or part of the path and domain name 300 of this first address A1.

Matching records 306 of the routing table 305 then provides 262 one or several selections 310 for the next or “second mail server”, through its IP address “IP-1” 309.

Available servers may be hierarchically sorted and selected by domain path and/or name or parts of it, similarly to the rules used for standard DNS dispatching.

In FIG. 4, the invalid first email address A1 is used for comparing 404 with the records of the ECOA routing table 405. An analysis 261 is done which comprises extracting 402 a key string 403 including all or part of the user part 400 of this first address A1.

In the shown example, a part 403 of the user part 400 is recognized as being probably a name or first name of the intended recipient user 119.

The routing table 405 memorizes a list of first names together with IP addresses of ECOA able servers to which ECOA resolving should be forwarded.

Matching records 406, 407 of the routing table 305 then provides 262 one or several selections 410 for the next or “second mail server”, through its IP address “IP-EN” 408 and “IP-FR” 409.

As the first name “PAUL” exists both in English and French but not classically in Chinese, only MTA servers “IP-EN” and “IP-FR” pertinent for this first name are selected.

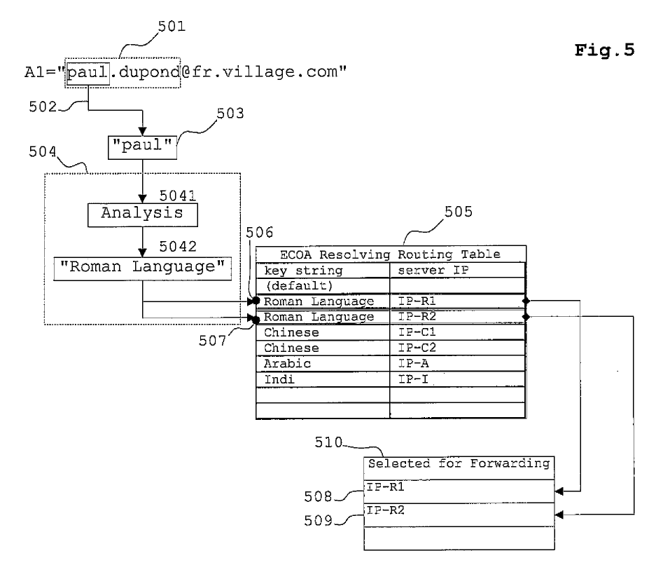

In FIG. 5, the invalid first email address A1 is used for comparing 504 with the records of the ECOA routing table 505. An analysis 261 is done which comprises extracting 502 a key string 503 including all or part of the user part 500 of this first address A1.

In the shown example, a part 503 of the user part 500 is recognized as being probably a name or first name of the intended recipient user 119.

A comparison 504 then comprises firstly an analysis 5041 of the extracted key string 503, leading to the key data 5042 representing the language family of the initial address A1.

The routing table 505 memorizes a list of language families together with IP addresses of ECOA-able servers to which ECOA resolving should be forwarded. Matching records 506, 507 of the routing table 505 then provides 262 one or several selections 510 for the next or “second mail server”, through its IP address “IP-EN” 508 and “IP-FR” 509.

As the first name “PAUL” classically exists only in Roman languages, only MTA servers “IP-R1” and “IP-R2” pertinent for this first name are selected.

As a non-exclusive alternative, an analysis may also be conducted on other types of features of the first address A1 or its user part, such as character code analysis. Such an analysis may also be conducted in or before the operation 502 of extracting the key string 503 out of the first address A1.

While the invention has been particularly shown and described mainly with reference to a preferred embodiment, it will be understood that various changes in form and detail may be made therein without departing from the spirit, and scope of the invention.

What is claimed is:

1. A method for processing electronic mails in a network comprising a plurality of mail servers, the method comprising:
at least a first mail server receiving a notification message representing an impossibility to reach a first electronic mail address for which a given electronic mail was intended;
the first mail server performing resolving forwarding, comprising sending all or part of the electronic mail to at least a second mail server, together with a datum indicating that a second substitution mail address, is to be searched for in replacement of the first mail address.

2. The method according to claim 1, further comprising a plurality of iterations of the resolving forwarding.

3. The method according claim 1, further comprising:
at least one mail server receiving the electronic mail together with a datum indicating to search for a substitution address;
the mail server receiving from at least one database a second electronic mail address, to be used as a substitution address for the first electronic mail address;
the mail server delivering the electronic mail to the substitution address, or transmitting the substitution address towards at least one other mail server with the substitution address as a replacement for the first mail address.

4. The method according to claim 1, wherein the resolving forwarding further comprises sending an identification datum identifying that the electronic mail has already been processed for substitution address by the at least one mail server.

5. The method according to claim 1, wherein at least one mail server is working as a Mail Transport Agent or as a Mail Delivery Agent in the network.

6. The method according to claim 5, further comprising comparing the first mail address with at least one routing table, for selecting the second mail server.

7. The method according to claim 6, further comprising:
extracting at least one key string including all or part of the user part of the first electronic mail address; and
comparing the key string with at least one routing table, for selecting the second mail server.

8. The method according to claim 7, wherein the extracting or comparing the key string comprises at least one linguistic analysis treatment.

9. The method according to claim 6, further comprising at least one mail server sending the substitution address as an update for the first address towards at least one mailbox routing table used in the network for routing electronic mails from senders to intended recipients.

10. A system for processing electronic mails in a network comprising a plurality of mail servers, comprising:
at least a first mail server receiving a notification message representing an impossibility to reach a first electronic mail address for which a given electronic mail was intended;
the first mail server performing resolving forwarding, comprising sending all or part of the electronic mail to at least a second mail server, together with a datum indicating that a second substitution mail address, is to be searched for in replacement of the first mail address.

11. The system according to claim 10, further comprising a plurality of iterations of the resolving forwarding.

12. The system according claim 10, further comprising:
at least one mail server receiving the electronic mail together with a datum indicating to search for a substitution address;
the mail server receiving from at least one database a second electronic mail address, to be used as a substitution address for the first electronic mail address;
the mail server delivering the electronic mail to the substitution address, or transmitting the substitution address towards at least one other mail server with the substitution address as a replacement for the first mail address.

13. The system according to claim 10, wherein the resolving forwarding further comprises sending an identification datum identifying that the electronic mail has already been processed for substitution address by the at least one mail server.

14. The system according to claim 10, wherein at least one mail server is working as a Mail Transport Agent or as a Mail Delivery Agent in the network.

15. The system according to claim 14, further comprising a system for comparing the first mail address with at least one routing table, for selecting the second mail server.

16. The system according to claim 15, further comprising:
a system for extracting at least one key string including all or part of the user part of the first electronic mail address, and for comparing the key string with at least one routing table, for selecting the second mail server.

17. The system according to claim 16, wherein the system for extracting and comparing performs at least one linguistic analysis treatment.

18. The system according to claim 15, further comprising at least one mail server sending the substitution address as an update for the first address towards at least one mailbox routing table used in the network for routing electronic mails from senders to intended recipients.
